(19) United States
(12) Patent Application Publication
(10) Pub. No.: US 2018/0123820 A1
(43) Pub. Date: May 3, 2018

(54) APPARATUS AND METHOD OF GENERATING INTERNET OF THINGS DATA

(71) Applicant: ELECTRONICS AND TELECOMMUNICATIONS RESEARCH INSTITUTE, Daejeon (KR)

(72) Inventor: Mal Hee KIM, Daejeon (KR)

(73) Assignee: ELECTRONICS AND TELECOMMUNICATIONS RESEARCH INSTITUTE, Daejeon (KR)

(21) Appl. No.: 15/802,407

(22) Filed: Nov. 2, 2017

(30) Foreign Application Priority Data
Nov. 3, 2016 (KR) 10-2016-0145805

(51) Int. Cl. H04L 12/28; G06F 17/30

(52) U.S. Cl. CPC H04L 12/2809; G06F 17/30023; G06N 99/005; H04L 12/281; G06F 17/30575

(57) ABSTRACT

An apparatus for generating IoT data is disclosed. The apparatus may search for a real IoT sensor capable of providing real IoT data desired by the user, collect the real IoT data desired by the user from the found real IoT sensor, and provide the collected real IoT data to the user. Also, when the real IoT sensor capable of providing the real IoT data desired by the user is not found, the apparatus may search for a realistic IoT sensor similar to the real IoT sensor, perform machine learning on the IoT data collected from the found realistic IoT sensor to generate realistic IoT data similar to the real IoT data, and provide the generated realistic IoT to the user.

### CROSS-REFERENCE TO RELATED APPLICATIONS

This application claims priority under 35 U.S.C. § 119 to Korean Patent Application No. 10-2016-0145805, filed on Nov. 3, 2016, the disclosure of which is incorporated herein by reference in its entirety.

### TECHNICAL FIELD

The present invention relates to an apparatus and method of generating Internet of things (IoT) sensor data, and more particularly, to an apparatus and method of generating IoT sensor data in an IoT environment.

### BACKGROUND

IoT technology connects all physical/virtual things over the Internet to enable users to use mutually necessary data or to perform a cooperative work through mutual control.

Machine learning technology is technology that predicts and provides data (or knowledge) necessary for a new environment by performing data-based learning based on the assigned purposes.

A combination of the IoT technology and the machine learning technology can provide a data provider with a new business model which enables creation of a new profit structure.

A machine learning function necessarily needs data fundamentally necessary for learning. Only when the data is data properly representing a target/environment which becomes the purpose of learning, an analysis result is effectively applied to a real environment. To exercise data analysis, real data are needed. In that cases, machine learning uses real data. In many cases, it is very hard to get real data collected from real environments. In that cases, machine learning can use generated data for initial setup or trial and error exercises, and then it can update the model to reflect real environment with real data. To make it effective, there needs a generated data which are similar to real data instead of generating data randomly, or generating based on some assumptions of a specific distribution. However, the data is really difficult to secure (difficult of installation/collection of sensors). Therefore, it is required to generate virtual data, and generally, a machine learning data analyzer randomly generates and uses a value under a specific condition or generates data on the assumption of a specific distribution. That is, it is required to develop a method of generating a value representing a real situation to provide the generated value to a data analyzer.

### SUMMARY

Accordingly, the present invention provides an apparatus and a method, which directly provide a dynamically changed real situation, based on IoT technology and when there is no IoT sensor for generating data, generate data through learning based on real data of a realistic IoT sensor.

The objects of the present invention are not limited to the aforesaid, but other objects not described herein will be clearly understood by those skilled in the art from descriptions below.

In one general aspect, a method of generating Internet of things (IoT) sensor data in an IoT environment includes: extracting search data, corresponding to IoT data desired by a user, from a query sentence of the user; searching a data storage unit, where metadata of each of a plurality of IoT sensors and IoT data measured by each of the plurality of IoT sensors are registered, to search for an IoT sensor (hereinafter referred to as a real IoT sensor), having metadata corresponding to the extracted search data, or an IoT sensor (hereinafter referred to as a realistic IoT sensor) having metadata similar to the extracted search data; when the real IoT sensor is found as a result of the search, obtaining IoT data of the real IoT sensor from the data storage unit to generate real IoT data, and when the real IoT sensor is not found and the realistic IoT sensor is found, obtaining IoT data of the realistic IoT sensor from the data storage unit and generating realistic IoT data similar to the real IoT data by using the obtained IoT data.

In another general aspect, an apparatus for generating Internet of things (IoT) sensor data in an IoT environment includes: a data storage unit where metadata of each of a plurality of IoT sensors and IoT data measured by each of the plurality of IoT sensors are registered; a query analyzer extracting search data, corresponding to IoT data desired by a user, from a query sentence of the user; a real IoT data generator searching a data storage unit to search for an IoT sensor (hereinafter referred to as a real IoT sensor) having metadata corresponding to the extracted search data, and when the real IoT sensor is found, obtaining IoT data of the real IoT sensor from the data storage unit to generate real IoT data; a realistic IoT sensor searcher, when the real IoT sensor is not found, searching for an IoT sensor (hereinafter referred to as a realistic IoT sensor) having metadata similar to the extracted search data according to a request of the real IoT data generator; and a realistic IoT data generator, when the realistic IoT sensor is found by the realistic IoT sensor searcher, obtaining IoT data of the realistic IoT sensor from the data storage unit and generating realistic IoT data similar to the real IoT data by using the obtained IoT data.

Other features and aspects will be apparent from the following detailed description, the drawings, and the claims.

### BRIEF DESCRIPTION OF THE DRAWINGS

FIG. 1 is a diagram schematically illustrating a whole configuration of an IoT system according to an embodiment of the present invention.

FIG. 2 is a block diagram illustrating an internal configuration of an IoT data generating apparatus (or a user apparatus) illustrated in FIG. 1.

FIGS. 3A and 3B are a flowchart illustrating an IoT data generating method according to an embodiment of the present invention.

### DETAILED DESCRIPTION OF EMBODIMENTS

Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention.

It will be understood that although the terms including an ordinary number such as first or second are used herein to describe various elements, these elements should not be limited by these terms. These terms are only used to distinguish one element from another element.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

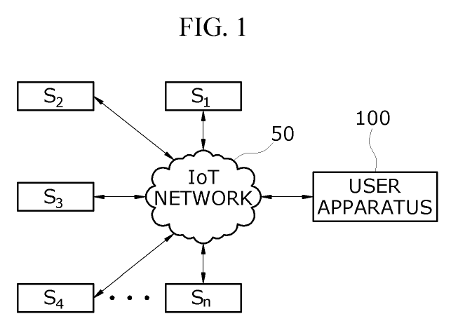

FIG. 1 is a diagram schematically illustrating a whole configuration of an IoT system according to an embodiment of the present invention.

Referring to FIG. 1, the IoT system according to an embodiment of the present invention may include a plurality of IoT sensor S₁ to Sₙ (where n is an integer equal to or more than two), which are connected to an IoT network 50 so as to enable communication, and a user apparatus 100 which generates IoT data desired by a user, based on IoT sensor data (hereinafter referred to as IoT data) collected from the plurality of IoT sensors S₁ to Sₙ.

The IoT network 50 may include all wired/wireless networks capable of connecting the user apparatus 100 to the plurality of IoT sensors S₁ to Sₙ, and for example, may include wireless private area network (WPAN), WiFI, 3G/4G/LTE, Bluetooth, Ethernet, BcN, satellite communication, Microwave, serial communication, PLC local Ad-hoc network, and Internet. Here, the Internet may include a plurality of routing agents and a plurality of processing agents. The internet may be a global system which uses a standard Internet protocol (for example, transmission control protocol/Internet protocol (TCP/IP)). The TCP/IP may be a communication rule that indicates a method of formatting, addressing, transmitting, routing, and receiving data at a destination.

Each of the plurality of IoT sensors S₁ to Sₙ may include an addressing-enabled interface (for example, an Internet protocol address, a Bluetooth identification (ID), a near field communication (NFC) ID, etc.) and may be used to represent an arbitrary object capable of transmitting information to one or more other IoT sensors through wired or wireless access.

The IoT sensors S₁ to Sₙ may each include a passive communication interface, such as a quick response (QR) code, a radio frequency ID (RFID) tag, or an NFC tag, and an active communication interface such as a modem, a transceiver, or a transmitter-receiver.

The IoT sensors S₁ to Sₙ may each have a specific attribute set (for example, an ID of an IoT sensor, a device status such as whether the IoT sensor is turned on or off, is opened or closed, is in an idle status or an active status, and is available for execution a task, a cooling or heating function, an environment monitoring or recording function, a light emitting function, a sound output function, etc.).

The attribute set may be embedded into or controlled/monitored by a central processing unit (CPU), a microprocessor, an application-specific integrated circuit (ASIC), etc., or may be connected to the IoT network 50 such as local Ad-hoc network or Internet. For example, the IoT sensors S₁ to Sₙ may each include an addressing-enabled interface for communicating with the IoT network 50 and may include refrigerators, toasters, ovens, microwave ovens, dishwashers, dishes, tools, washing machines, drying machines, furnaces, air conditioners, thermostats, televisions, lighting devices, vacuum cleaners, spring coolers, electric meters, gas meters, temperature sensors, humidity sensors, thermal sensors, gas sensors, illumination sensors, ultrasonic sensors, radar sensors, position sensors, motion sensors, image sensors, etc. but are not limited thereto.

The IoT sensors S₁ to Sₙ may be indirectly connected to the IoT network 50 through an access point without being directly connected to the IoT network 50.

The user apparatus 100 may include cellular phones, smartphones, desktop computers, laptop computers, tablet computers, personal digital assistants (PDAs), wearable devices, etc. Therefore, the IoT network 50 may be configured by a combination of devices (for example, home appliances, measurement devices, etc.) having no accessibility to the Internet and devices (for example, laptop or desktop computers, cellular phones, etc.) accessible to the Internet. The user apparatus 100 may be an IoT-based server.

In FIG. 1, the user apparatus 100 and IoT sensors S₁ to Sₙ are illustrated as individual elements, but the user apparatus 100 may be an IoT sensor without being limited thereto.

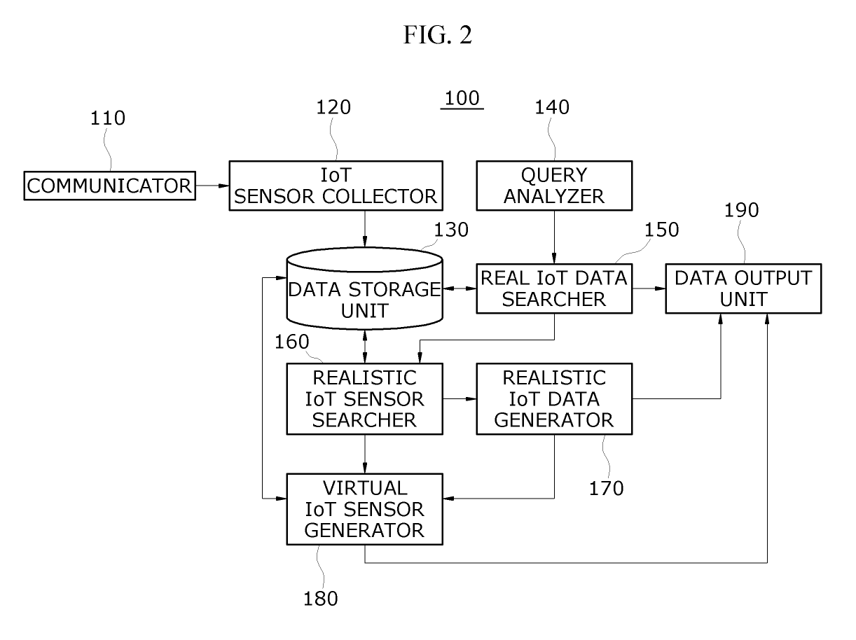

Hereinafter, a user apparatus for generating IoT data will be described in detail with reference to FIG. 2.

FIG. 2 is a block diagram illustrating an internal configuration of the user apparatus 100 illustrated in FIG. 1.

Referring to FIG. 2, the user apparatus 100 may provide IoT data to a user. Here, the IoT data may include real-time data, in which a situation (for example, a temperature, humidity, heat, illumination, distance, position, etc.) which dynamically changes in an IoT environment is reflected in real time, and historical data obtained accumulating past data.

In order to provide the IoT data to the user, the user apparatus 100 may search for a real IoT sensor capable of providing real IoT data desired by the user, collect the real IoT data desired by the user from the found real IoT sensor, and provide the collected real IoT data to the user.

On the other hand, when the real IoT sensor is not found, the user apparatus 100 may search for a realistic IoT sensor similar to the real IoT sensor. When the realistic IoT sensor is found, the user apparatus 100 may perform machine learning on the IoT data collected from the found realistic IoT sensor to generate realistic IoT data similar to the real IoT data and may provide the generated realistic IoT to the user.

The user apparatus 100 may add a virtual IoT sensor, configured with the found realistic IoT sensor, as a search target. That is, when the real IoT sensor is not found, the user apparatus 100 may search for the virtual IoT sensor before searching for the realistic IoT sensor. When the virtual IoT sensor is found, the user apparatus 100 may generate IoT data (hereinafter referred to as virtual IoT data) collected from the found virtual IoT sensor and may provide the generated virtual IoT data to the user.

As described above, in order to provide real IoT data, virtual IoT data, or realistic IoT data, the user apparatus 100 may include a communicator 110, a IoT sensor collector 120, a data storage unit 130, a query analyzer 140, a real IoT data searcher 150, a realistic IoT sensor searcher 160, a realistic IoT data generator 170, a virtual IoT sensor generator 180, and a data output unit 190.

The communicator 110 may communicate with the IoT sensors S₁ to Sₙ over the IoT network 50. To this end, the communicator 110 may include a communication module which is embedded into or controlled by a central processing unit (CPU), a microprocessor, or an application-specific integrated circuit (ASIC) so as to support wireless private area network (WPAN), WiFI, 3G/4G/LTE, Bluetooth, Ethernet, BcN, satellite communication, Microwave, serial communication, PLC local Ad-hoc network, and Internet.

The communicator 110 may receive metadata of each of the IoT sensors and IoT data generated by each IoT sensor. Here, the metadata of each IoT sensor attribute information (for example, an ID of an IoT sensor, a kind of the IoT sensor, a measurement item measured by the IoT sensor, a measurement unit of the measurement item measured by the IoT sensor, a time when the IoT sensor measures the measurement target, a position of the IoT sensor, a device status such as whether the IoT sensor is turned on or off, is opened or closed, is in an idle status or an active status, and is available for execution a task, a cooling or heating function, an environment monitoring or recording function, a light emitting function, a sound output function, etc.) about each of the IoT sensors.

The IoT sensor collector 120 may collect the metadata of each IoT sensor received through the communicator 110 and IoT data measured by each IoT sensor and may store the collected metadata of each IoT sensor and IoT data in the data storage unit 130. The IoT sensor collector 120 may be an intermediate storage medium for transferring data, received through the communicator 110, to the data storage unit 130, and for example, may be a buffer memory.

The query analyzer 140 may analyze a query sentence input from the user to extract a search condition (or search data), associated with IoT data desired by the user, from the query sentence.

If the query sentence is written in a natural language, the query analyzer 140 may extract the search condition by using a rule-based method using a dictionary and a rule and a statistics-based method of automatically extracting a rule by using a dictionary and information about a part of speech.

The rule-based method and the statistics-based method are technologies well known to those skilled in the art, and thus, their detailed descriptions are omitted. However, the search condition may include domain information, place information, time information, data type information, etc. For example, the search condition may include various pieces of information associated with an ID of an IoT sensor, a kind of the IoT sensor, a measurement item measured by the IoT sensor, a measurement unit of the measurement item measured by the IoT sensor, a time when the IoT sensor measures the measurement target, a position of the IoT sensor, etc.

The real IoT data searcher 150 may have a search function of searching the data storage unit 130. The real IoT data searcher 150 may search for the metadata of each IoT sensor stored in the data storage unit 130 to search for at least one IoT sensor suitable for (or corresponding to) the search condition extracted by the query analyzer 140.

When at least one real IoT sensor suitable for (matching or corresponding to) the search condition is found, the real IoT data searcher 150 may obtain past and current real IoT data, generated by the found at least one real IoT sensor, from the data storage unit 130 and may provide the obtained real IoT data to the data output unit 190.

The data output unit 190 may process the at least one piece of real IoT data, provided from the real IoT data searcher 150, into a visual type, an auditory type, or a combination type thereof and may output data obtained through the processing. The data output unit 190 may be an image output device including an image processing module and a display screen, a voice output device including an audio processing module and a speaker, or an output device configured by a combination thereof.

When a real IoT sensor suitable for the search condition is not found as a result obtained by the real IoT data searcher 150 searching the data storage unit 130, the realistic IoT sensor searcher 160 may search the data storage unit 130 according to a request of the real IoT data searcher 150 to search for the realistic IoT sensor similar to the real IoT sensor.

In detail, the realistic IoT sensor searcher 160 may search the data storage unit 130 according to the request (a request message or a request command) of the real IoT data searcher 150 to search for at least one realistic IoT sensor similar to a real IoT sensor, and when the realistic IoT sensor is found, the realistic IoT sensor searcher 160 may obtain pass and current IoT data, generated by the found realistic IoT sensor, from the data storage unit 130.

Moreover, when the real IoT data searcher 150 fails to search for a real IoT sensor suitable for the search condition, the realistic IoT sensor searcher 160 may search the data storage unit 130 for determining whether there is a virtual IoT sensor configured with a sensor pool of a realistic IoT sensor previously found based on a past query sentence, before searching for the realistic IoT sensor, and when it is determined that there is the virtual IoT sensor, the real IoT data searcher 150 may obtain and generate virtual IoT data of the virtual IoT sensor from the data storage unit 130 and may transmit the obtained virtual IoT data to the data output unit 190.

Moreover, without directly obtaining the virtual IoT data from the data storage unit 130, the realistic IoT sensor searcher 160 may issue a request (a request message or a request command), to the virtual IoT sensor generator 180, to obtain and generate the virtual IoT data from the data storage unit 130 and transmit the obtained virtual IoT data to the data output unit 190.

The realistic IoT sensor searcher 160 may search for the realistic IoT sensor similar to the real IoT sensor by using similarity scores between search data representing the search condition and pieces of metadata stored in the data storage unit 130.

In detail, the realistic IoT sensor searcher 160 may calculate the similarity scores between the search data representing the search condition and the pieces of metadata stored in the data storage unit 130, select metadata having a similarity score which is equal to or greater than (highest) a reference value, and search for at least one IoT sensor, corresponding to the selected metadata, as at least one realistic IoT sensor.

On the other hand, the realistic IoT sensor searcher 160 may search for a realistic IoT sensor which is the most suitable for the search condition, based on a semantic search technique.

The realistic IoT sensor searcher 160 may obtain at least one piece of IoT data, generated from the found at least one realistic IoT sensor, from the data storage unit 130 and may provide the obtained at least one piece of IoT data to the realistic IoT data generator 170.

The realistic IoT data generator 170 may learn, through machine learning, the at least one piece of IoT data provided from the realistic IoT sensor searcher 160 to generate realistic IoT data similar to real IoT data desired by the user.

The realistic IoT data generator 170 may provide the generated realistic IoT data to the data output unit 190, and the data output unit 190 may process the realistic IoT data into a visual type, an auditory type, or a combination type thereof and may output data obtained through the processing.

The virtual IoT sensor generator 180 may be an element for registering the above-described virtual IoT sensor in the data storage unit 130. The virtual IoT sensor generator 180 may configure a sensor pool with the realistic IoT sensor found from the realistic IoT data searcher 160 and may generate the configured sensor pool as the virtual IoT sensor.

Moreover, the virtual IoT sensor generator 180 may store and register the generated virtual IoT sensor and the IoT data, generated by the virtual IoT sensor, as the virtual IoT data in the data storage unit 130. In this case, an ID may be allocated to the virtual IoT sensor so as to enable the realistic IoT sensor searcher 160 to search for the virtual IoT sensor. Therefore, metadata of the virtual IoT sensor may include the ID and metadata of a realistic IoT sensor configuring the virtual IoT sensor and may be stored and registered in the data storage unit 130.

As described above, the user apparatus 100 according to an embodiment of the present invention may search for a real IoT sensor capable of providing IoT data desired by the user and may provide real IoT data, collected from the found real IoT sensor, to the user. When the real IoT sensor capable of providing the IoT data desired by the user is not found, the user apparatus 100 may search for a realistic IoT sensor similar to the real IoT sensor according to the semantic search technique and may learn, through machine learning, IoT data collected from the found realistic IoT sensor to provide realistic IoT data similar to the real IoT data to the user, thereby providing the user with machine learning-based IoT data in which a dynamically changed situation is reflected in real time even in an IoT environment.

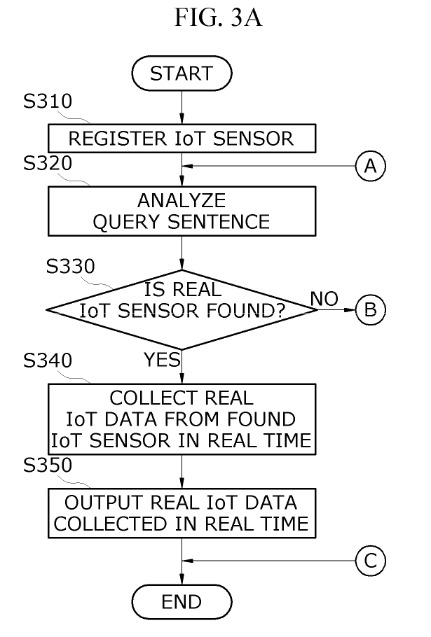

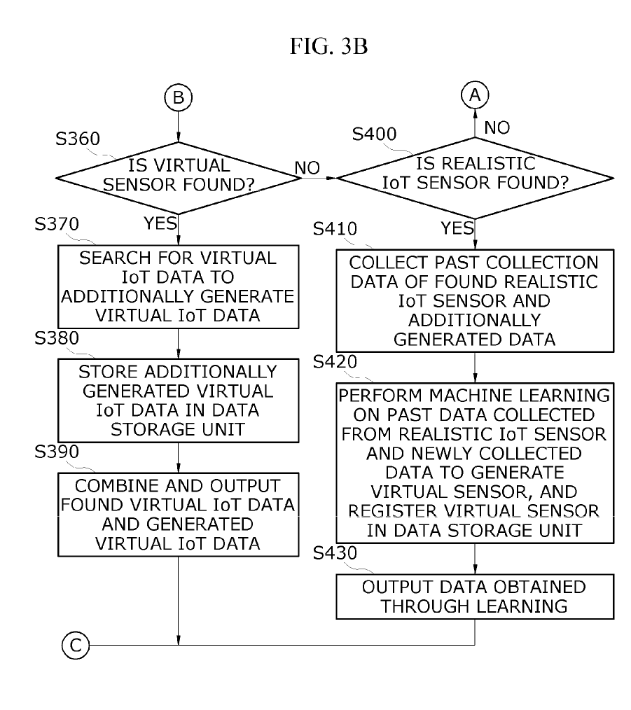

FIGS. 3A and 3B are a flowchart illustrating an IoT data generating method according to an embodiment of the present invention. In describing each step of FIG. 3, details overlapping the details described above with reference to FIGS. 1 and 2 are omitted or will be briefly described, and to help understand description, the IoT data generating method will be described with reference to FIG. 3 along with FIGS. 1 and 2. Also, unless specially described, an element for performing each step illustrated in FIG. 3 may be assumed as the user apparatus 100 illustrated in FIGS. 1 and 2.

Referring to FIGS. 3A and 3B, first, in step S310, an operation of registering the IoT sensors S₁ to Sₙ connected to the IoT network 50 may be performed. In the operation of registering the IoT sensors S₁ to Sₙ, metadata of the IoT sensors S₁ to Sₙ may be collected over the IoT network 50, and the collected metadata may be stored in the data storage unit 130.

Subsequently, in step S320, an operation of analyzing a query sentence input from a user may be performed. In detail, the user apparatus 100 may analyze the query sentence input from the user to extract a search condition, associated with the IoT data desired by the user, from the query sentence. Here, if the query sentence is written in a natural language, the query analyzer 140 may extract the search condition from the query sentence by using the rule-based method and the statistics-based method. The search condition may include domain information, place information, time information, and data type information, and in detail, may include various pieces of information associated with an ID of an IoT sensor, a kind of the IoT sensor, a measurement item measured by the IoT sensor, a measurement unit of the measurement item measured by the IoT sensor, a time when the IoT sensor measures the measurement target, a position of the IoT sensor, etc.

Subsequently, in step S330, an operation of searching for a real IoT sensor, which is suitable for the search condition extracted in step S320, from among the IoT sensors S₁ to Sₙ registered in step S310 may be performed. In the operation of searching for the real IoT sensor, for example, the user apparatus 100 may analyze metadata of each of the registered IoT sensors S₁ to Sₙ to determine whether there is metadata suitable for the search condition. When the real IoT sensor suitable for the search condition is found, the user apparatus 100 may proceed to step S340, and when not found, the user apparatus 100 may proceed to step S360.

When the real IoT sensor suitable for the search condition is found, an operation of collecting real IoT data from the found real IoT sensor in real time may be performed in step S340.

Subsequently, in step S350, an operation of processing the collected real IoT data into a visual type, an auditory type, or a combination type thereof to output data obtained through the processing may be performed so as to obtain real IoT data collected in real time and previously collected data from the data storage unit 130 and provide the user with the obtained data.

When the real IoT sensor suitable for the search condition is not found in step S330, the user apparatus 100 may search for a virtual IoT sensor, configured with realistic IoT sensors found based on a past query sentence, in the data storage unit 130 in step S360.

Subsequently, in step S370, when the virtual IoT sensor is found in the data storage unit 130, the user apparatus 100 may search for virtual IoT data (previously generated virtual IoT data) of the virtual IoT sensor in the data storage unit 130, and simultaneously, in step S380, the user apparatus 100 may store and register new data, currently generated based on a current query sentence by the virtual IoT sensor, in the data storage unit 130.

Subsequently, in step S390, the user apparatus 100 may combine previously generated data and currently generated virtual IoT data, which are generated by the virtual IoT sensor found based on the current query sentence, to output data obtained through the combination.

When the virtual IoT sensor is not found in step S360, an operation of searching for a realistic IoT sensor, which is similar to the real IoT, from among the IoT sensors S₁ to Sₙ registered in the data storage unit 130 may be performed in step S400.

In the operation of searching for the realistic IoT sensor, similarity scores between search data representing the search condition and metadata of the IoT sensors S₁ to Sₙ may be calculated. For example, a sensor pool may be configured with IoT sensors corresponding to metadata where a similarity score is equal to or greater than (or highest) a reference value, and the IoT sensors of the sensor pool may be found as realistic IoT sensors. On the other hand, the user apparatus 100 may search for realistic IoT sensors which are the most suitable for the search condition, based on the semantic search technique.

For example, when the realistic IoT sensor is not found, the user apparatus 100 may issue a re-request, to the user, to input a new query sentence for reanalyzing the query sentence input from the user.

Subsequently, in step S410, when the realistic IoT sensor is found, the user apparatus 100 may obtain previously generated IoT data (past realistic IoT data) and currently and newly generated realistic IoT data (current realistic IoT data), which are generated by the found realistic IoT sensor found, from the data storage unit 130.

Subsequently, in step S420, the user apparatus 100 may perform machine learning on the past realistic IoT data and the current realistic IoT data to configure a sensor pool with the learned realistic IoT data and the found realistic IoT sensor and may configure and register the configured sensor pool as a virtual IoT sensor in the data storage unit 130.

Subsequently, in step S430, in order to enable the learned realistic IoT data to be provided to the user, the user apparatus 100 may process the learned realistic IoT data into a visual type, an auditory type, or a combination type thereof to output data obtained through the processing, thereby ending all operations of generating IoT data.

As described above, in the IoT data generating apparatus and method according to an embodiment of the present invention, if a cloud method is used as a method of securing IoT data essential for developing/using data analysis technology which is very quickly advancing recently, a profit of a data provider collected through a real IoT sensor, a profit of a provider who dynamically generates and provides data similarly to the real IoT data by learning corresponding data, and a profit structure for providing portable data obtained through integration of the profits may be created, thereby providing a new business model with a real IoT data consumer and an IoT data provider.

The blocks of FIG. 2 illustrating the IoT data generating apparatus according to an embodiment of the present invention should be understood as an example where the principle of the invention is specified in functional viewpoint.

Similarly, it should be understood that the flowchart of FIG. 3 may be substantially realized in a computer-readable medium and represents various processes performed by a computer or a processor irrespective of whether the computer or the processor is clearly illustrated or not.

The blocks of FIG. 2 and the steps of FIG. 3 illustrated as a processor or a concept similar thereto may be implemented by using hardware capable of executing software, in addition to dedicated hardware.

When the blocks of FIG. 2 and the steps of FIGS. 3A and 3B are implemented by a processor, a function of each of the blocks illustrated in FIG. 2 and a process performed in each step of FIGS. 3A and 3B may be provided by a single dedicated processor, a single shared processor, or a plurality of individual processors, and some of which may be shared.

Moreover, the clear use of terms described as a processor, control, or a concept similar thereto should not be construed by exclusively citing hardware capable of executing software, and should be understood as implicitly including digital signal processor (DSP) hardware and a read-only memory (ROM), a random access memory (RAM), and a nonvolatile memory for storing software without limitation. Also, other well-known hardware may be included.

As described above, according to the embodiments of the present invention, if the cloud method is used as a method of securing IoT data essential for developing/using data analysis technology which is very quickly advancing at present, a profit of a data provider collected through a real IoT sensor, a profit of a provider who dynamically generates and provides data similarly to the real IoT data by learning corresponding data, and a profit structure for providing portable data obtained through integration of the profits may be created, thereby providing a new business model with a real IoT data consumer and an IoT data provider.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating Internet of things (IoT) sensor data in an IoT environment, the method comprising:
extracting search data, corresponding to IoT data desired by a user, from a query sentence of the user;
searching a data storage unit, where metadata of each of a plurality of IoT sensors and IoT data measured by each of the plurality of IoT sensors are registered, to search for an IoT sensor (hereinafter referred to as a real IoT sensor), having metadata corresponding to the extracted search data, or an IoT sensor (hereinafter referred to as a realistic IoT sensor) having metadata similar to the extracted search data;
when the real IoT sensor is found as a result of the search, obtaining IoT data of the real IoT sensor from the data storage unit to generate real IoT data, and when the real IoT sensor is not found and the realistic IoT sensor is found, obtaining IoT data of the realistic IoT sensor from the data storage unit and generating realistic IoT data similar to the real IoT data by using the obtained IoT data.

2. The method of claim 1, wherein the generating comprises performing machine learning on the IoT data of the realistic IoT sensor obtained from the data storage unit to generate the realistic IoT data.

3. The method of claim 1, wherein the searching comprises searching the data storage unit according to a semantic search technique to search for the real IoT sensor and the realistic IoT sensor.

4. The method of claim 1, further comprising:
configuring a sensor pool with the found realistic IoT sensor;
generating a virtual IoT sensor from the configured sensor pool; and
registering the virtual IoT sensor and IoT data, measured by the virtual IoT sensor, as virtual IoT data in the data storage unit.

5. The method of claim 4, wherein
the searching further comprises searching the data storage unit to search for the virtual IoT sensor having metadata corresponding to the extracted search data, and
the metadata of the virtual IoT sensor comprises metadata of the found realistic IoT sensor configuring the sensor pool.

6. The method of claim 5, wherein the searching comprises searching the data storage unit to perform a search in the order of the real IoT sensor, the virtual IoT sensor, and realistic IoT sensor.

7. The method of claim 4, wherein the generating comprises, when the virtual IoT sensor is found as a result of the search, obtaining the virtual IoT data of the virtual IoT sensor from the data storage unit to generate the virtual IoT data.

8. An apparatus for generating Internet of things (IoT) sensor data in an IoT environment, the apparatus comprising:
a data storage unit where metadata of each of a plurality of IoT sensors and IoT data measured by each of the plurality of IoT sensors are registered;
a query analyzer extracting search data, corresponding to IoT data desired by a user, from a query sentence of the user;
a real IoT data generator searching a data storage unit to search for an IoT sensor (hereinafter referred to as a real IoT sensor) having metadata corresponding to the extracted search data, and when the real IoT sensor is found, obtaining IoT data of the real IoT sensor from the data storage unit to generate real IoT data;
a realistic IoT sensor searcher, when the real IoT sensor is not found, searching for an IoT sensor (hereinafter referred to as a realistic IoT sensor) having metadata similar to the extracted search data according to a request of the real IoT data generator; and
a realistic IoT data generator, when the realistic IoT sensor is found by the realistic IoT sensor searcher, obtaining IoT data of the realistic IoT sensor from the data storage unit and generating realistic IoT data similar to the real IoT data by using the obtained IoT data.

9. The apparatus of claim 8, wherein the realistic IoT data generator performs machine learning on the IoT data of the realistic IoT sensor obtained from the data storage unit to generate the realistic IoT data.

10. The apparatus of claim 8, wherein the realistic IoT sensor searcher searches the data storage unit according to a semantic search technique to search for metadata similar to the extracted search data.

11. The apparatus of claim 8, further comprising: a virtual IoT sensor generator, wherein the virtual IoT sensor generator configures a sensor pool with the found realistic IoT sensor, generates a virtual IoT sensor from the configured sensor pool, and registers the generated virtual IoT sensor and IoT data, measured by the virtual IoT sensor, as virtual IoT data in the data storage unit.

12. The apparatus of claim 11, wherein
when the real IoT sensor is not found, before searching for the realistic IoT sensor, the realistic IoT sensor searcher searches the data storage unit to search for the virtual IoT sensor having metadata corresponding to the extracted search data, and
the metadata of the virtual IoT sensor comprises metadata of the found realistic IoT sensor configuring the sensor pool and an identification (ID) for identifying the virtual IoT sensor.

13. The apparatus of claim 11, wherein when the virtual IoT sensor is found, the realistic IoT data generator obtains the virtual IoT data of the virtual IoT sensor from the data storage unit to generate the virtual IoT data.
